(19) United States
(12) Patent Application Publication
(10) Pub. No.: US 2020/0332478 A1
(43) Pub. Date: Oct. 22, 2020

(54) ARTIFICIAL TURF

(71) Applicant: KOLON GLOTECH, Inc., Seoul (KR)

(72) Inventors: Se Jun HWANG, Daegu (KR); Jong Pil KIM, Daegu (KR); Yeoung Hoon KWON, Gumi-si, Gyeongbuk (KR); Ki Tae BAE, Daegu (US)

(21) Appl. No.: 16/766,075

(22) PCT Filed: Jul. 23, 2018
(86) PCT No.: PCT/KR2018/008286

§ 371 Date: May 21, 2020

(30) Foreign Application Priority Data
Nov. 21, 2017 (KR) 10-2017-0155921
May 24, 2018 (KR) 10-2018-0059309

(51) Int. Cl. E01C 13/08; B32B 5/02; B32B 5/26

(52) U.S. Cl. CPC E01C 13/08; B32B 5/26; B32B 5/02

(57) ABSTRACT

This invention relates to an artificial turf. The artificial turf comprises a base layer, a buffer layer positioned under the base layer and formed of single-fiber nonwoven fabrics, a pile unit penetrating the base layer and the buffer layer to be turfed, wherein the one end of the pile unit is projected to the upper direction of the base layer and the other end of the pile unit is positioned undersurface of the buffer layer, and a backing layer in contact with the undersurface of the buffer layer and the other end of the pile unit and formed of long-fiber non-woven fabrics. In this case, at least a portion of the buffer layer penetrates the base layer and is positioned on upper surface of the base layer to form pores.

### TECHNICAL FIELD

The present invention relates to an artificial turf, and in particular to an artificial turf having improved drainage and peel strength as well as low surface temperature.

### BACKGROUND ART

Generally, artificial turfs are capable of keeping inherent color and not subject to be restrained according to environment condition so that it is easy to control them after construction. Artificial turfs suffered from higher cost than natural grasses but are preferable because they can be used semi-permanently, have easy maintenance and administration, and conformal surface suitable for work out.

These artificial turfs include a multiplicity of pile yarns with a length ranging from about 20 mm to 70 mm, which are fixed to a substrate, and a backing layer combined with the substrate in order that the pile yarn is not separated from the substrate.

Artificial turfs are mounted on the ground formed of stone dust, pebble, and so forth. To drain, they have the substrate and the backing layer with drain holes. However, the drain holes are stopped by silica, elastomers, and the like, which are installed for buffering.

### DISCLOSURE OF INVENTION

### Technical Problem

It is therefore an object of the present invention to provide a technique for improving drainage, reducing surface temperature, and improving peel strength for construction of an artificial turf.

### Solution to Problem

It is therefore an object of the present invention to provide a technique for improving drainage, reducing surface temperature, and improving peel strength for construction of an artificial turf.

Pursuant to embodiments of the present invention provides an artificial turf comprising a base layer, a buffer layer positioned under the base layer and formed of single-fiber nonwoven fabrics, a pile unit penetrating the base layer and the buffer layer to be turfed, wherein the one end of the pile unit is projected to the upper direction of the base layer and the other end of the pile unit is positioned undersurface of the buffer layer, and a backing layer in contact with the undersurface of the buffer layer and the other end of the pile unit and formed of long-fiber non-woven fabrics. In this case, at least a portion of the buffer layer penetrates the base layer and is positioned on upper surface of the base layer to form pores.

Pursuant to embodiments of the present invention, the buffer layer includes a first fabric and a second fabric having different melting point.

Pursuant to embodiments of the present invention, the melting point of the first fabric is ranging from 120° C. to 150° C., and the melting point of the second fabric is ranging from 200° C. to 260° C.

Pursuant to embodiments of the present invention, the mixture ratio of the first and second fabrics is in a weight ratio of 10 to 50:50 to 90.

Pursuant to embodiments of the present invention, the buffer layer includes the first fabric having low melting point and the second fabric having high melting point, and the buffer layer, the first fabric having low melting point and the other end of the pile unit are mixed each other and cured to be combined and pullout strength of the buffer layer exceeds 80N.

Pursuant to embodiments of the present invention, the first fabric having low melting point covers the other end of the pile unit.

Pursuant to embodiments of the present invention, the buffer layer is formed of polypropylene or polyester.

Pursuant to embodiments of the present invention, the buffer layer has thickness ranging from 1 mm to 3 mm, and the backing layer has a thickness ranging from 0.1 mm to 0.4 mm.

Pursuant to embodiments of the present invention, if an adhesive is coated on undersurface of the backing layer, the adhesive penetrates the backing layer and the buffer layer.

Pursuant to embodiments of the present invention, the backing layer and the other end of the pile unit are melted, mixed, and cured to be combined and peel strength of the backing layer exceeds 90N.

Pursuant to embodiments of the present invention, the backing layer is formed of polypropylene or polyester.

Pursuant to embodiments of the present invention, the buffer layer includes a core and a sheath covering the core, which are formed by a sheath-core complex spinning, and a melting point of the sheath is lower than that of the core.

Pursuant to embodiments of the present invention, the sheath and the other end of the pile unit are melted, mixed each other, and cured to be combined.

Pursuant to embodiments of the present invention, the core is formed of polypropylene or polyester, and the sheath is formed of polyethylene or polypropylene.

Pursuant to embodiments of the present invention, the base layer and the buffer layer are not melted and combined each other by a part of the buffer layer penetrating the base layer, and the upper surface of the backing layer, the undersurface of the base layer, and the other end of the pile unit are melted, mixed each other, and cured to be combined.

Pursuant to embodiments of the present invention, the buffer layer and the backing layer contain moisture, and the moisture is vaporized toward one end of the pile unit by at least a portion of the buffer layer penetrating the base layer to lower a surface of the one end of the pile unit.

Pursuant to embodiments of the present invention, at least a portion of the buffer layer on the upper surface of the base layer is in a dot-shaped, and single-fiber nonwoven fabrics come untied.

Pursuant to embodiments of the present invention, a liquid synthetic-resin adhesive coated on the backing layer is further included. In this case, the synthetic-resin adhesive enhances stiffness of the base layer and the backing layer.

Pursuant to embodiments of the present invention, the permeability of the base layer is ranging from 12 to 15 cc/cm²/sec, the permeability of the buffer layer is ranging from 290 to 300 cc/cm²/sec, and the permeability of the backing layer is ranging from 340 to 350 cc/cm²/sec

Pursuant to embodiments of the present invention, the base layer, the buffer layer, and backing layer are combined each other, and the permeability thereof is ranging from 55 to 65 cc/cm²/sec

Pursuant to embodiments of the present invention provides an artificial turf comprising, a base layer, a buffer layer positioned under the base layer and formed of single-fiber nonwoven fabrics, a pile unit penetrating the base layer and the buffer layer to be turfed, wherein the one end of the pile unit is projected to the upper direction of the base layer and the other end of the pile unit is positioned undersurface of the buffer layer, and a backing layer in contact with the undersurface of the buffer layer and the other end of the pile unit and formed of long-fiber non-woven fabrics. In this case, the buffer layer is formed of lattice-form textiles to have permeability.

The foregoing summary is illustrative only and is not intended to be in any way limiting. In addition to the illustrative aspects, embodiments, and features described above, further aspects, embodiments, and features will become apparent by reference to the drawings and the following detailed description.

### Advantageous Effects of Invention

According to embodiments of the present invention, the backing layer, which fixes the buffer layer connected to the base layer and the pile unit tufted to the buffer layer, is formed of non-woven fabric. As a result, the artificial turf according to the present invention has high weather resistance property and durability, high fluid absorption and drainage due to improved permeability, dimensional stability with respect to outdoor temperature change by reducing temperature through moisture-absorption and permeability, and antistatic effect.

According to embodiments of the present invention, if a temperature of one end of the pile unit becomes higher than that of the buffer layer and the backing layer on condition that the buffer layer and the backing layer absorbs fluid, the fluid of the backing layer and the buffer layer may be vaporized through an exposed section over the base layer. The surface temperature of one end of the pile unit is lowered by the vaporized fluid, so that the surface temperature of the artificial turf is controlled to reduce temperature of artificial turf.

According to embodiments of the present invention, the base layer and the buffer layer are strongly combined by the exposed section and pile unit penetrating the base layer. As a result, adhesive is not needed, thereby lowering manufacturing cost and preventing environmental pollution.

According to embodiments of the present invention, the first fabric of the buffer layer, the other end of the pile unit, and the long fiber of the backing layer are melted, cured, and combined. As a result, the combination of artificial turf becomes increased to have high pullout strength. The adhesive is penetrated to the buffer layer to improve peel strength after construction.

According to embodiments of the present invention, since the backing layer, the buffer layer, the base layer, and the pile unit are formed of the same materials such as polypropylene or polyester, recyclable resins having the same properties without a separating process after collecting. Thus, the amount of waste matters can be dramatically reduced in replacing artificial turfs and environmental pollution by the disposal of waste matters can be prevented.

All such changes, modifications, variations and other uses and applications which do not depart from the spirit and scope of the invention are deemed to be covered by the invention which is limited only by the claims which follow.

### BRIEF DESCRIPTION OF DRAWINGS

FIG. 1 is a schematic view illustrating an artificial turf according to an embodiment of the present invention;

FIG. 2 is a perspective view illustrating separated backing and buffer layers described in FIG. 1;

FIG. 3 is an expanded sectional view of A of FIG. 1;

FIG. 4 is a photograph of the artificial turf of FIG. 1;

FIGS. 5 to 9 are analytical curves of heat flow of the buffer layer;

FIG. 10 is a schematic view showing sheath-core of the buffer layer; and

FIG. 11 is a schematic view showing the artificial turf of FIG. 1 engaged in the ground.

### MODE FOR THE INVENTION

Preferred embodiments of the present invention will now be described in detail with reference to the accompanying drawings. It should be noted that whenever possible, the same reference numerals will be used throughout the drawings and the description to refer to the same or like parts. In describing the present invention, detailed descriptions of related known functions or configurations are omitted in order to avoid making the essential subject of the invention unclear.

As used herein, the terms “about”, “substantially”, etc. are intended to allow some leeway in mathematical exactness to account for tolerances that are acceptable in the trade and to prevent any unconscientious violator from unduly taking advantage of the disclosure in which exact or absolute numerical values are given so as to help understand the invention.

As utilized herein, the term “fabric” is intended to include articles produced by weaving or knitting, non-woven fabrics, fiber webs, and so forth.

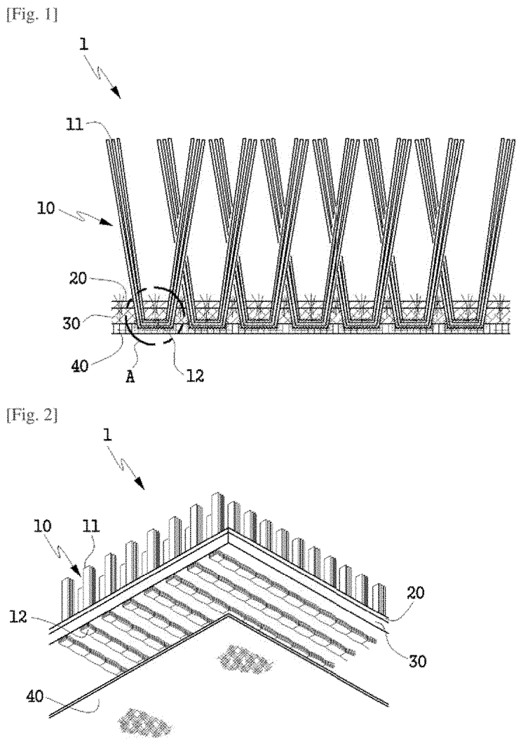

Hereinafter, an artificial turf according to an embodiment of the present invention will be described referring to FIGS. 1 to 4.

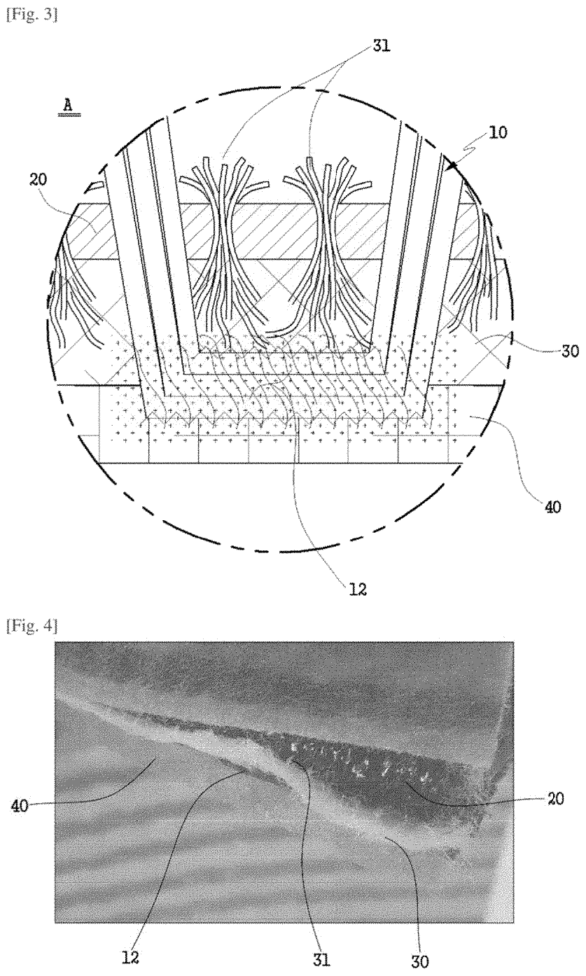

FIG. 1 is a schematic view illustrating an artificial turf according to an embodiment of the present invention. FIG. 2 is a perspective view illustrating separated backing and buffer layers described in FIG. 1. FIG. 3 is an expanded sectional view of A of FIG. 1. FIG. 4 is a photograph of the artificial turf of FIG. 1;

Referring to FIGS. 1 to 4, the artificial turf 1 according to an embodiment of the present invention comprises a base layer 20, a buffer layer 30, a pile unit 10, and a backing layer 40 and improve drainage and lowers surface temperature thereof.

The base layer 20 and the buffer layer 30 are stacked in one entity. The pile unit 10 penetrates the base layer 20 and the buffer layer 30 to be tufted. The one end 11 of the pile unit 10 is located on the base layer 20, and the other end 12 of the pile unit 10 is undersurface of the buffer layer 30. The backing layer 40 is located under the other end of the pile unit 10 and connected thereto and prevents the pile unit from leaving. The backing layer 40 and the pile unit 10, and the buffer layer 30 and the pile unit 10 are combined each other. The buffer layer 30, the pile unit 10, and the backing layer 40 are melted and combined each other.

The pile unit 10 is formed of polyolefin, and in more detail, a plurality of pile yarns formed of polypropylene, polyethylene, polyethylene terephthalate, polyamide, and the like. A central part (the other end of the pile unit) of the pile yarn is located between the buffer layer 30 and the backing layer 40, and both ends (one end of the pile unit) penetrate the buffer layer 30 and the base layer 20 to be exposed over the base layer 20. In this case, the pile yarns under the buffer layer 30 are melted and combined each other, and the pile yarns on the base layer 20 are separated each other. For uprightness of the separated pile yarns, buffer materials such as silica and elastomers may be installed on the base layer 20.

The base layer 20 has a knitted fabric structure and made of polypropylene having excellent chemical resistance, mechanical property, and thermal property. The base layer 20 is melted at a temperature exceeding 120° C. The base layer 20 is made of natural fabric. The permeability of the base layer 20 is ranging from 12 to 15 cc/cm²/sec in a weight ranging from 80 to 120 g/m².

The buffer layer 30 is positioned undersurface of the base layer 20 and made of single-fiber nonwoven fabrics such as polypropylene or polyester. Polyester may be polyethylene terephthalate. The buffer layer 30 made of single-fiber nonwoven fabrics has high absorptiveness, maintainability, and density. Also, the buffer layer 30 made of single-fiber nonwoven fabrics have various thickness and are not wrinkled so that there are no wrinkles in the artificial turf installed on the ground. In addition, the tips of the buffer layer 30 are not come untied, and the artificial turf can be freely cut out toward any direction and excellent stiffness and bulky property.

The buffer layer 30 is thicker than the base layer 20. The thickness of the buffer layer 30 is ranging from 1 mm to 3 mm. If the thickness of the buffer layer 30 is under 1 mm, tufting efficiency of the pile unit 10 is decreased and the processing workability, dimensional stability, and durability of the artificial turf may be decreased. If the thickness of the buffer layer 30 exceeds 3 mm, the weight of the artificial turf is increased, fusion energy is increased, and manufacturing cost is increased.

At least a portion (hereinafter, referred to as “an exposed section 31”) of the buffer layer 30 penetrates the base layer 20 to be exposed on the base layer 30. As a result, the exposed section 31 exists in a dot shape. The exposed section 31 on the base layer 20 comes untied to be spread so that the base layer 20 is not separated from the buffer layer 30. For this reason, the buffer layer 30 and the base layer 20 are combined without melting.

In the meanwhile, the buffer layer 30 is connected to the outside through the exposed section 31 to form pores and to be connected to one end of the pile unit 10. Through the exposed section 31, fluid like rain water inflows to the buffer layer 30. Unlike this, the fluid inflowed to the buffer layer 30 may be vaporized through the exposed section 31 toward the one end of the pile unit 10. Due to the vaporization of the fluid, the surface temperature of the other end of the pile unit 10 may be lowered.

The buffer layer 30 includes a first fabric with high melting point ranging from 120° C. to 150° C. and a second fabric with low melting point ranging from 200° C. to 260° C. The fiber length, crimp, and fineness of the first and second fibers may be ranged from 39 mm to 64 mm, 5% to 30%, and 3 denier to 8 denier, respectively. Thus, the buffer layer 30 may be melted at a temperature exceeding 120° C.

If the melting point of the first fiber is less than 120° C., dimensional stability is reduced in combining the buffer layer 30 and the backing layer 40. There is high possibility that bonding strength is reduced by difference of the melting point of pile yarns and transformation according to outer temperature. In contrast, if the melting point of the first fiber exceeds 150° C., melting energy are excessively used in combining the buffer layer 30 and the backing layer 40 and the pile yarns of the pile unit 10 are excessively melted to damage appearance of product.

Since the first fabric is melted at a temperature ranging from 120° C. to 150° C., the use amount of melting energy and generation amount of carbon dioxide may be reduced. The second fabric is made of moisture absorption materials to be capable of lowering temperature and performing a function of anti-mite and anti-bacteria.

The first fabric covers the other end of the pile unit 10 to be combined with melting. Since the pile unit 10 and the first fabric are melted and combined each other, the pullout force of the pile unit 10 is improved. The pullout force of the pile unit 10 may be 80N. And, the first fabric is combined with the second fabric and pile unit to be maintained in a constant shape.

The mixture ratio of the first and second fabrics may be in a weight ratio of 10 to 50: 50 to 90. In this case, if the first fabric is less than 10 and second fabric exceeds 90, the bonding strength of the backing layer 40 and the pile yarns may be reduced due to insufficiency of the first fabric. In contrast, if the first fabric exceeds 50 and second fabric is less than 50, the bonding strength of the backing layer 40 and the pile yarns becomes increased but it is not easy to separate the backing layer 40, the pile unit 10, and the buffer layer 30 for recycling of a collected artificial turf 1.

Meanwhile, the ratio of the first fabric and the second ratio may be 1: 4.1 to 7.0. In this case, the melting calorie measured by DSC (Differential Scanning calorimetry) of the first fabric is ranged from 134 J/g to 215 J/g, and the melting calorie measured by DSC (Differential Scanning calorimetry) of the second fabric is ranged from 757 J/g to 932 J/g.

The melting calorie ratio of the first and second fabrics is shown as the following Table 1.

TABLE 1

| | Classification | | | | | | | | | |
|---|---|---|---|---|---|---|---|---|---|---|
| | 1 Time | | 2 Times | | 3 Times | | 4 Times | | 5 Times | |
| | First | Second | First | Second | First | Second | First | Second | First | Second |
| | Fabric | Fabric | Fabric | Fabric | Fabric | Fabric | Fabric | Fabric | Fabric | Fabric |
| Melting | 167 | 757 | 156 | 910 | 134 | 932 | 215 | 872 | 179 | 823 |
| Calorie | | | | | | | | | | |
| (J/g) | | | | | | | | | | |

| | | | | | |
|---|---|---|---|---|---|
| Ratio | 1:4.5 | 1:5.8 | 1:7.0 | 1:4.1 | 1:4.6 |

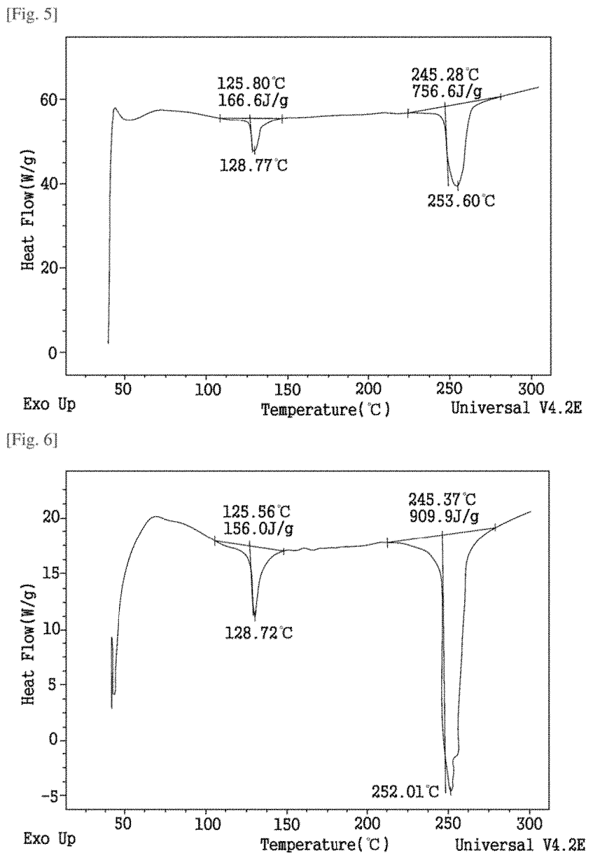

If the ratio of the first and second fabrics is 1:4.5, the melting calorie of the first fabric is 167 J/g at 129° C., and the melting calorie of the second fabric is 757 J/g at 254° C. (See FIG. 5).

If the ratio of the first and second fabrics is 1:5.8, the melting calorie of the first fabric is 156 J/g at 129° C., and the melting calorie of the second fabric is 910 J/g at 252° C. (See FIG. 6).

If the ratio of the first and second fabrics is 1:7.0, the melting calorie of the first fabric is 134 J/g at 128° C., and the melting calorie of the second fabric is 932 J/g at 253° C. (See FIG. 7).

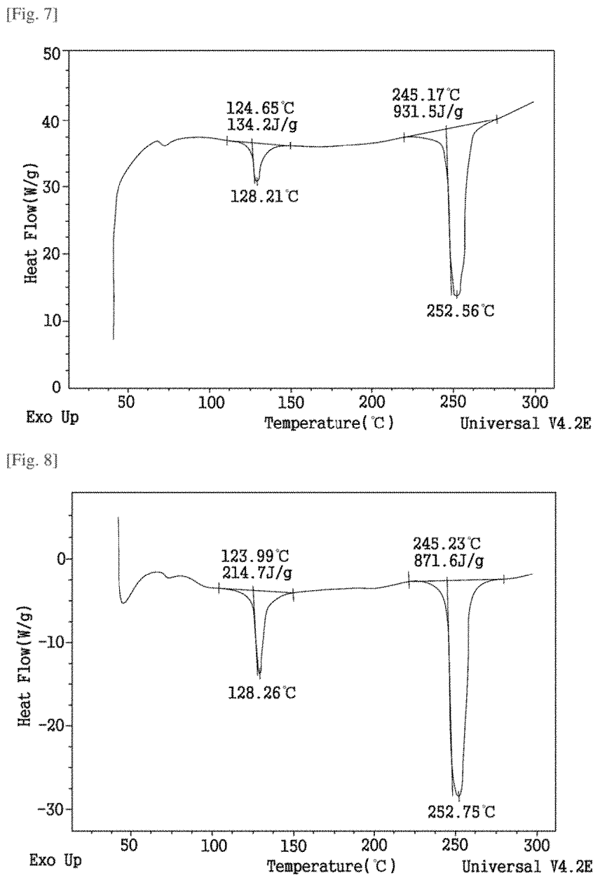

If the ratio of the first and second fabrics is 1:4.1, the melting calorie of the first fabric is 215 J/g at 128° C., and the melting calorie of the second fabric is 872 J/g at 253° C. (See FIG. 8).

If the ratio of the first and second fabrics is 1:4.6, the melting calorie of the first fabric is 179 J/g at 129° C., and the melting calorie of the second fabric is 823 J/g at 253° C. (See FIG. 9).

It was shown that there is melting calorie difference according to the ratio of the first and second fabrics. Based on the melting calorie difference, the ratio of the first and second fabrics can be determined.

In the meanwhile, the buffer layer 30 includes a core 32 and a sheath 33 covering the core 32, which is formed using a sheath-core complex spinning (See FIG. 10). The core 32 is formed of polypropylene or polyester, and the sheath 33 is formed of polyethylene or polypropylene. The conjugated fiber may be formed of nonwoven fabrics.

The conjugated fiber includes the first fabric of high melting point and the second fabric of low melting point. The buffer layer 30 formed of conjugated fiber is softer than polyester staple fiber and has uniform thermal adhesive, excellent bulkiness, and chemical resistance.

In addition, the buffer layer 30 may be formed of nonwoven fabrics mixed with conjugated fibers and staple fibers. In this case, the sheath of the conjugated fiber has low melting point lower in comparison with the staple fiber.

This buffer layer 30 is ranging from 240 to 350 cc/cm²/sec in a weight ranging from 80 to 160 g/m².

The backing layer 40 is formed of long-fiber nonwoven fabrics, which are made of polypropylene, polyester, and the like. The polyester may be polyethylene terephthalate. The backing layer 40 formed of long-fiber nonwoven fabrics has excellent mechanical strength and weather resistance. Due to mechanical strength, transformations and property changes do not occur for long period of time. The backing layer 40 has excellent water permeability to effectively drain. As a result, stresses concentrated on the ground become distributed, thereby improving bearing power of a road.

The long fiber of the backing layer 40 may be melted at a temperature exceeding 120° C. The long fiber of the backing layer 40 is melted to combine the first fabric of the buffer layer 30 and the other end of the pile unit 10. Accordingly, the pile unit 10, and the buffer layer 30 and the backing layer 40 connected to the base layer 20 are combined and formed in one entity without additional adhesive to have dimensional stability, and the backing layer 40 is not peeled under 90N.

Since the backing layer 40 is formed of long-fiber nonwoven fabrics and formed in a thickness thinner than the buffer layer 30. The thickness of the backing layer 40 may be ranged from 01 mm to 0.4 mm. If the thickness of the backing layer 40 is less than 0.1 mm, permeability is excellent but the processing workability, dimensional stability, and long-term durability of the artificial turf may be decreased. In contrast, if the thickness of the backing layer 40 exceeds 0.4 mm, an adhesive for fixing the artificial turf 1 on the ground penetrates the backing layer 40 so that efficiency may be decreased.

This backing layer 40 is ranging from 340 to 350 cc/cm²/sec in a weight ranging from 30 to 70 g/m². If the permeability is less than 350 cc/cm²/sec, air and fluid of the buffer layer 30 are not drained smoothly.

In order to increase the stiffness of the base layer 20 and the backing layer 40, liquid synthetic resin adhesive (Latex) may be coated. By coating the liquid synthetic resin adhesive, the backing layer 40, the buffer layer 30, the other end of the pile unit 10, and the base layer 20 are strongly fixed each other so that the durability as well as the stiffness of the artificial turf can be increased.

Hereinafter, the above-mentioned artificial turf will be described in more detail.

On condition that the base layer 20 and the buffer layer 30 are overlapped, a part of the buffer layer 30, that is, the exposed section 31 penetrates the base layer 20 to be exposed on the base layer 20. Through the exposed section 31, the base layer 20 and the buffer layer 30 are combined without an adhesive in one entity. The pile yarns are tufted in the base layer 20 and the buffer layer 30. The backing layer 40 is positioned under the other end of the pile unit 10 located under the buffer layer 30. The backing layer 40 is in contact with the undersurface of the buffer layer 30 and melted with the other end of the pile unit 10 and combined each other.

The first fabric of the buffer layer 30 and the other end of the pile unit 10 are melted and mixed each other, and then cured to be combined. The other end of the pile unit 10 and the long fiber of the backing layer 40 are melted and mixed each other, and then cured to be combined. In this case, the first fabric and the long fiber of the backing layer 40 are melted to cover the pile unit 10. As a result, the pullout strength of the pile unit 10 and the buffer layer 30 and the peel strength of the backing layer 40 and the pile unit 10 can be enhanced.

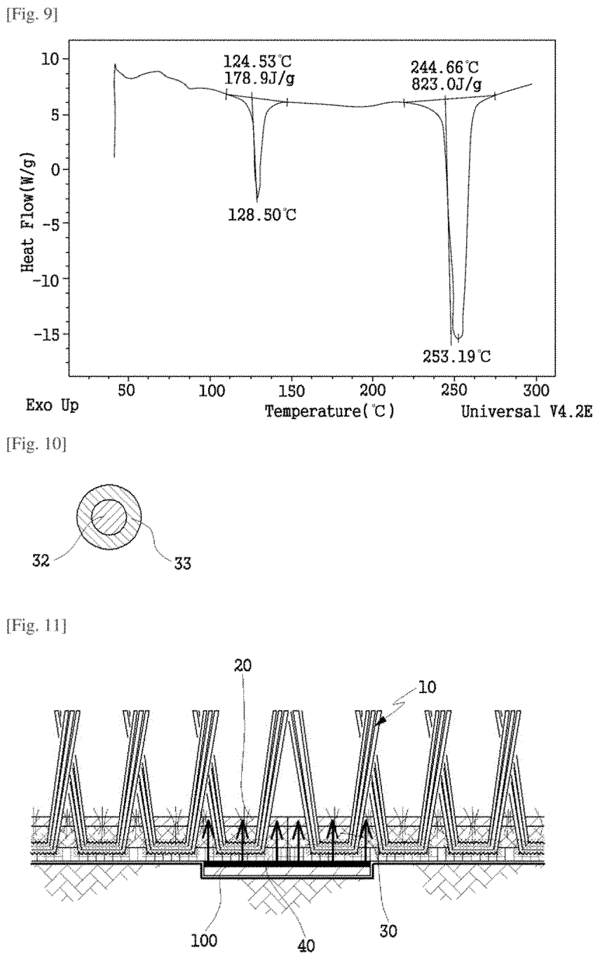

Referring to FIG. 11, the rolled artificial turf with a predetermined length and width is provided in roll form to be mounted on the ground. In this case, in order to fix the artificial turf to the ground, an adhesive 100 is coated on sheets on the ground. The backing layer 40 is formed of the long-fiber nonwoven fabrics and has a thickness ranging from 0.1 mm to 0.4 mm, so that the coated adhesive penetrates the backing layer 40 to go up toward one direction of the pile unit 10 through the buffer layer 30 and the base layer 20. The adhesive is not in contact with only surface of the backing layer 40 but goes up the backing layer 40 and the buffer layer 30 toward one direction of the pile unit 10, so that the artificial turf can be strongly fixed on the ground.

When rain water (fluid) drops on the artificial turf, the fluid can be absorbed to the buffer layer 30 formed of nonwoven fabric through the exposed section 31 positioned on the base layer 20. The backing layer 40 is also formed of nonwoven fabric to be capable of absorbing fluid of the buffer layer 30. Thus, the drainage of the artificial turf can be improved by the buffer layer 30 and the backing layer 40.

If the temperature of the other end of the pile unit 10 is higher than that of the buffer layer 30 and the backing layer 40 under the condition that the buffer layer 30 and the backing layer 40 absorbs fluid, the fluid of the buffer layer 30 and the backing layer 40 can be vaporized over the base layer 20 through the exposed section 31. The surface temperature of the other end of the pile unit 10 becomes lowed by fluid vaporization, thereby controlling the surface temperature of the pile unit 10.

In this artificial turf 1, the buffer layer 30 and the backing layer 40 are formed of nonwoven. As a result, the artificial turf has high weather resistance property and durability, high fluid absorption and drainage due to improved permeability, dimensional stability with respect to outdoor temperature change by reducing temperature through moisture-absorption and permeability, and antistatic effect.

Also, since the backing layer 40, the buffer layer 30, the base layer 20, and the pile unit 10 are formed of the same materials such as polypropylene or polyester, recyclable resins having the same properties without a separating process after collecting. Thus, the amount of waste matters can be dramatically reduced in replacing artificial turfs and environmental pollution by the disposal of waste matters can be prevented.

Other embodiments of the present invention have mostly used elements of the embodiments described referring to FIGS. 1 to 11. However, in the present embodiment, the buffer layer may be formed in overall net structure in which warps and wefts are formed in a lattice-form. The fineness of the warps is ranging from 600 to 1,000 denier, and the fineness of the wefts is 1,400 to 2,000 denier. The density of warps is ranging from 2/cm to 4/cm, and the density of wefts is ranging from 2/cm to 4/cm. If the density of the warp and weft exceeds 4/cm, permeability may be reduced. In this case, the permeability can be improved by the overall net structure of the buffer layer. Due to improvement of permeability, air flow is improved and the absorption and vaporization of fluid become efficient so that the surface temperature of the artificial turf can be effectively controlled. Other elements of the embodiments according to FIGS. 1 to 11 except for the buffer layer are applicable.

### EXPERIMENTAL EXAMPLE 1

### Permeability According to Weight of Base Layer

### EXAMPLE 1

The base layer of 100 g/m² was formed in a knitted fabric structure using polypropylene yarns. In this case, the fineness of warps of the knitted fabric is ranging from 300 denier to 500 denier, and the fineness of wefts of the knitted fabric is ranging from 1,000 denier to 1,400 denier. The density of warps of the knitted fabric is ranging from 90/cm to 130/cm, and the density of wefts of the knitted fabric is ranging from 50/cm to 70/cm.

### COMPARATIVE EXAMPLE 1

A base layer of 75 g/m² was formed in the same manner as in Example 1.

### COMPARATIVE EXAMPLE 2

A base layer of 125 g/m² was formed in the same manner as in Example 1.

The permeability of the base layers obtained from Example 1, and Comparative Examples 1 and 2 was evaluated at 20° C. and 1 atm, and the result was shown in the following Table 2.

TABLE 2

| | Base layer | Permeability |
|---|---|---|
| | (g/m²) | (cc/cm²/sec) |
| Example 1 | 100 | 20 |
| Comparative Example 1 | 75 | 9 |
| Comparative Example 2 | 125 | 13 |

The permeability of the base layer of 100 g/m² was 20 cc/cm²/sec as shown in Example 1. However, the permeability of the base layer of 75 g/m² in Comparative Example 1 was high in comparison with Example 1 but has insufficient dimensional stability. The permeability of the base layer of 125 g/m² in Comparative Example 2 was low in comparison with Example 1. It is preferable that the permeability of the base layer was ranging from 15 cc/cm²/sec to 25 cc/cm²/sec, and was 20 cc/cm²/sec in Example 1. It was shown that the base layer of Comparative Examples 1 and 2 was not suitable because it did not satisfy the permeability.

### EXPERIMENTAL EXAMPLE 2

### Permeability According to Weight of Buffer Layer

### EXAMPLE 2

The fiber length, crimp, and fineness of buffer layer were 50 mm, 20%, and 3 denier to 3 denier, respectively. Using the first fabric with high melting point and the second fabric with low melting point, non-woven fabric of 3 mm thickness was formed to fabricate the buffer layer of g/m². The first and second fabrics were staple fibers.

### Comparative Example 3

A buffer layer of 75 g/m² was formed in the same manner as in Example 2.

### COMPARATIVE EXAMPLE 4

A buffer layer of 165 g/m² was formed in the same manner as in Example 2.

The permeability of the buffer layers obtained from Example 2, and Comparative Examples 3 and 4 was evaluated at 20° C. and 1 atm, and the result was shown in the following Table 3.

TABLE 3

| | Buffer layer | Permeability |
|---|---|---|
| | (g/m²) | (cc/cm²/sec) |
| Example 2 | 120 | 295 |
| Comparative Example 3 | 75 | 270 |
| Comparative Example 4 | 165 | 220 |

The permeability of the buffer layer of 120 g/m² was 295 cc/cm²/sec as shown in Example 2. However, the permeability of the buffer layer of 75 g/m² in Comparative Example 3 was high in comparison with Example 2, but the durability of the buffer layer was reduced. The permeability of the buffer layer of 165 g/m² in Comparative Example 3 was low in comparison with Example 2 so that air flow was reduced.

It is preferable that the permeability of the buffer layer was ranging from 240 cc/cm²/sec to 350 cc/cm²/sec, and was 295 cc/cm²/sec in Example 2. It was shown that the buffer layer of Comparative Examples 3 and 4 was not suitable because it did not satisfy the permeability.

### EXPERIMENTAL EXAMPLE 3

### Permeability According to Weight of Backing Layer

### EXAMPLE 3

A non-woven fabric of 0.4 mm thickness was fabricated using long fibers made of polypropylene, polyester, and so forth to fabricate a backing layer of 50 g/m²

### COMPARATIVE EXAMPLE 5

A backing layer of 25 g/m²was formed in the same manner as in Example 3.

### COMPARATIVE EXAMPLE 6

A backing layer of 75 g/m²was formed in the same manner as in Example 3.

The permeability of the backing layers obtained from Example 3, and Comparative Examples 5 and 6 was evaluated at 20° C. and 1 atm, and the result was shown in the following Table 4.

TABLE 4

| | Backing layer | Permeability |
|---|---|---|
| | (g/m²) | (cc/cm²/sec) |
| Example 3 | 50 | 345 |
| Comparative Example 5 | 25 | 390 |
| Comparative Example 6 | 75 | 300 |

The permeability of the backing layer of 50 g/m² was 3455 cc/cm²/sec as shown in Example 3. However, the permeability of the backing layer of 25 g/m² in Comparative Example 5 was high in comparison with Example 3, but the durability of the backing layer was reduced. The permeability of the backing layer of 75 g/m² in Comparative Example 6 was low in comparison with Example 3 so that air flow was reduced.

It is preferable that the permeability of the backing layer was ranging from 330 cc/cm²/sec to 360 cc/cm²/sec, and was 345 cc/cm²/sec in Example 3. It was shown that the backing layer of Comparative Examples 5 and 6 was not suitable because it did not satisfy the permeability.

### EXPERIMENTAL EXAMPLE 4

### Permeability, Drainage, and Pullout Strength of Artificial Turf

### EXAMPLE 4

A base layer formed of a knitted fabric and a buffer layer formed of staple fibers made of a first fabric with high melting point and a second fabric with low melting point were combined tuft pile yarns, and then were combined with a backing layer formed of long fibers to fabricate an artificial turf of 250 g/m². In this case, the first and second fabrics were melted to be combined.

### COMPARATIVE EXAMPLE 7

Pile yarns were tufted in a base layer, and the base layer was coated with styrene-butadiene rubber so as not to separate the pile yarns to fabricate an artificial turf.

### COMPARATIVE EXAMPLE 8

Pile yarns were tufted in a base layer, and the base layer was combined with a backing layer formed of polyethylene film so as not to separate the pile yarns to fabricate an artificial turf.

The drainage, permeability, pullout strength, peel strength, efficiency for reducing temperature, and dimensional stability of the artificial turf obtained from Example 4, and Comparative Examples 5 and 8 was evaluated and the results were shown in the following Table 5.

TABLE 5

| | | Compar- | Compar- | |
|---|---|---|---|---|
| | | ative | ative | |
| | | Exam- | Exam- | Exam- |
| | | ple 7 | ple 8 | ple 8 |
| Drainage (mm/hr) | | 950 | 950 | More than |
| | | | | 2,000 |
| Permeability (cc/cm2/sec) | | None | None | 60.12 |
| PulloutStrength (N) | Before | 71 | 92 | 94 |
| | waterlogging | | | |
| | After | 66 | 93 | 95 |
| | waterlogging | | | |
| | (72 hr) | | | |
| | After | 52 | 91 | 92 |
| | waterlogging | | | |
| | (168 hr) | | | |
| | After | 36 | 90 | 93 |
| | waterlogging | | | |
| | (336 hr) | | | |
| | Apply buffer | — | — | 101 |
| | layer & first | | | |
| | fabric with low | | | |
| | melting point | | | |
| Not | — | — | 94 | 101 |
| apply buffer | | | | |
| layer & first | | | | |
| fabric with low | | | | |
| melting point | | | | |

| | | | |
|---|---|---|---|
| Peel Strength (N) | 92 | 75 | |
| Efficiency for reducing Temp. | No | No | Yes |
| Dimensional Stability | Partially | Partially | — |
| | Modifi- | Modifi- | |
| | cation | cation | |

In Example 4, the artificial turf was formed of knitted fabrics, the buffer layer was formed of staple fiber non-woven fabrics, and the backing layer was formed of long-fiber non-woven fabrics to have excellent drainage and permeability in comparison with Comparative Examples 7 and 8.

It is preferable that the permeability of the artificial turf is ranging from 50 cc/cm²/sec to 70 cc/cm²/sec, and was 60.12 cc/cm²/sec in Example 4. However, there was no permeability in Comparative Examples 7 and 8. While an additional drainage hole was needed for drainage of the artificial turf in Comparative Examples 7 and 8, the buffer layer and the backing layer were formed of non-woven fabrics in Example 4 and the base layer was formed of knitted fabrics, thereby performing a function to drain without an additional drainage hole. In other words, it was shown that the drainage was improved due to high permeability.

In addition, the first fabric of the buffer layer with low melting point and the pile unit were melted to be combined, a connecting section connected to the buffer layer was exposed over the base layer so that the end of the buffer layer come untied to be spread, and the long fibers of the backing layer and the pile unit were melted to be combined in one entity. As a result, it was shown that the pullout strength of the artificial turf in Example 4 was higher than Comparative Examples 7 and 8. It was shown that the binding force of the buffer layer, the pile unit, and the backing layer was excellent, and the peel strength of them was high.

Additionally, in Example 4, fluid contained in the buffer layer and the backing layer was vaporized toward one direction of the pile unit through the connecting section due to high permeability to accomplish excellent antistatic and lowering temperature. By lowering temperature, dimensional stability was improved so that the artificial turf was not modified by outer temperature.

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein

1. An artificial turf comprising:
a base layer;
a buffer layer positioned under the base layer and formed of single-fiber nonwoven fabrics;
a pile unit penetrating the base layer and the buffer layer to be tufted, wherein the one end of the pile unit is projected to the upper direction of the base layer and the other end of the pile unit is positioned undersurface of the buffer layer; and
a backing layer in contact with the undersurface of the buffer layer and the other end of the pile unit and formed of long-fiber non-woven fabrics, wherein at least a portion of the buffer layer penetrates the base layer and is positioned on upper surface of the base layer to form pores.

2. The artificial turf of claim 1,
wherein the buffer layer includes a first fabric and a second fabric having different melting point.

3. The artificial turf of claim 2,
wherein the melting point of the first fabric is ranging from 120° C. to 150° C., and the melting point of the second fabric is ranging from 200° C. to 260° C.

4. The artificial turf of claim 2,
wherein the mixture ratio of the first and second fabrics is in a weight ratio of 10 to 50:50 to 90.

5. The artificial turf of claim 1,
wherein the buffer layer includes the first fabric having low melting point and the second fabric having high melting point, and the buffer layer, the first fabric having low melting point and the other end of the pile unit are mixed each other and cured to be combined and pullout strength of the buffer layer exceeds 80N.

6. The artificial turf of claim 5,
wherein the first fabric having low melting point covers the other end of the pile unit.

7. The artificial turf of claim 1,
wherein the buffer layer is formed of polypropylene or polyester.

8. The artificial turf of claim 1,
wherein the buffer layer has thickness ranging from 1 mm to 3 mm, and the backing layer has a thickness ranging from 0.1 mm to 0.4 mm.

9. The artificial turf of claim 8,
wherein if an adhesive is coated on undersurface of the backing layer, the adhesive penetrates the backing layer and the buffer layer.

10. The artificial turf of claim 1,
wherein the backing layer and the other end of the pile unit are melted, mixed, and cured to be combined and peel strength of the backing layer exceeds 90N.

11. The artificial turf of claim 1,
wherein the backing layer is formed of polypropylene or polyester.

12. The artificial turf of claim 1,
wherein the buffer layer includes a core and a sheath covering the core, which are formed by a sheath-core complex spinning, and a melting point of the sheath is lower than that of the core.

13. The artificial turf of claim 12,
wherein the sheath and the other end of the pile unit are melted, mixed each other, and cured to be combined.

14. The artificial turf of claim 12,
wherein the core is formed of polypropylene or polyester, and the sheath is formed of polyethylene or polypropylene.

15. The artificial turf of claim 1,
wherein the base layer and the buffer layer are not melted and combined each other by a part of the buffer layer penetrating the base layer, and the upper surface of the backing layer, the undersurface of the base layer, and the other end of the pile unit are melted, mixed each other, and cured to be combined.

16. The artificial turf of claim 1,
wherein the buffer layer and the backing layer contain moisture, and the moisture is vaporized toward one end of the pile unit by at least a portion of the buffer layer penetrating the base layer to lower a surface of the one end of the pile unit.

17. The artificial turf of claim 1,
wherein at least a portion of the buffer layer on the upper surface of the base layer is in a dot-shaped, and single-fiber nonwoven fabrics come untied to be spread.

18. The artificial turf of claim 1,
further comprising a liquid synthetic-resin adhesive coated on the backing layer, wherein the synthetic-resin adhesive enhances stiffness of the base layer and the backing layer.

19. The artificial turf of claim 1,
wherein the permeability of the base layer is ranging from 12 to 15 cc/cm²/sec, the permeability of the buffer layer is ranging from 290 to 300 cc/cm²/sec, and the permeability of the backing layer is ranging from 340 to 350 cc/cm²/sec

20. The artificial turf of claim 1,
wherein the base layer, the buffer layer, and backing layer are combined each other, and the permeability thereof is ranging from 55 to 65 cc/cm²/sec

21 An artificial turf comprising:
a base layer;
a buffer layer positioned under the base layer and formed of single-fiber nonwoven fabrics;
a pile unit penetrating the base layer and the buffer layer to be turfed, wherein the one end of the pile unit is projected to the upper direction of the base layer and the other end of the pile unit is positioned undersurface of the buffer layer; and
a backing layer in contact with the undersurface of the buffer layer and the other end of the pile unit and formed of long-fiber non-woven fabrics, wherein the buffer layer is formed of lattice-form textiles to have permeability.
